(19) United States
(12) Patent Application Publication
(10) Pub. No.: US 2013/0014574 A1
(43) Pub. Date: Jan. 17, 2013

(54) METHOD OF PASSAGE OPENNESS INSPECTION OF A PRODUCT, IN PARTICULAR OF COOLANT PASSAGES OF CYLINDER HEADS AND A DEVICE FOR PERFORMING THE METHOD

(71) Applicants: Martin Balog, Bratislava (SK); Marek Bartos, Bystricany (SK); Vladimir Drzik, Bratislava (SK); Igor Kocis, Zvolen (SK); Peter Krssak, Bratislava (SK)

(72) Inventors: Martin Balog, Bratislava (SK); Marek Bartos, Bystricany (SK); Vladimir Drzik, Bratislava (SK); Igor Kocis, Zvolen (SK); Peter Krssak, Bratislava (SK)

(21) Appl. No.: 13/261,399

(22) PCT Filed: Mar. 17, 2011
(86) PCT No.: PCT/SK11/50002

§ 371 Date: Aug. 10, 2012

(30) Foreign Application Priority Data
Mar. 17, 2010 (SK) PP50008-2010

(51) Int. Cl. G01M 15/00

(52) U.S. Cl. 73/114.68

(57) ABSTRACT

A product, which passages are to be checked is brought to the measuring position, at least one measuring probe containing at minimum one emitting element and at minimum one receiving element is moved toward or inserted into openings of the product passages or an assembly of measuring probes consisting of at minimum one measuring probe containing at minimum one emitting element and at minimum one measuring probe containing at minimum one receiving element is moved toward or inserted into the opening of the product passages, following the part of the assembly consisting of at minimum one measuring probe containing at minimum one emitting element emitting in range of visible spectrum and/or infrared spectrum in the region of wavelength from 400 nm to 1500 nm is turned on and on the measuring probe, containing the receiving element, that forms a pair with the just working emitting element a response—a signal, size of which depends on amount of passed light, is measured, a signal amount is analysed and compared with an expected value. The procedure is then repeated with other sets of emitting and receiving elements on an identically arranged assembly of measuring probes or alternatively arranged assembly of measuring probes moved forward or inserted into another passage opening(s) of the product, until a required amount of measurements enabling to analyse openness of requisite amount of passages in the whole inspected product is achieved, wherein individual assemblies of measuring probes are designed so that the routes between all designed pairs of emitting element-receiving element cover sufficient amount of passages for evaluation of the analysed product.

### TECHNICAL FIELD

An invention relates to a method for inspection of passage openness of a product, in particular of coolant passages of a cylinder head and to a device for implementation thereof.

### STATE OF THE ART

A described system is used to check accuracy of manufacturing of a product, in particular of cylinder heads of spark-ignition and internal combustion engines for automobiles and other similar engines. The said products are primarily manufactured by a gravity casting method into an iron mould with a sand core, which consists of several complicated pieces forming a negative mould of a finished product. Part of the cast is a system of various interconnected or separate passages forming coolant passages in the finished product that is a part of the cast. Due to the used technology of sand moulds, damage in the sand core and manufacturing of a faulty product may occur. The primary faults are in particular various partial or complete blockages of passages in a certain part of the passage system caused by partial or complete break of the sand core or by a narrowed diameter or absence thereof. In the process of casting fluid metal leaks into the place of the damaged sand core and it reduces or completely narrows the diameter of the cavity. It is also possible that a sand mould residuum remains in the passage when the sand core is removed and that results in passage diameter reduction. The said is a critical defect and it shall be detected and the faulty pieces shall be eliminated from further production.

Present-day methods of detection of the damage can be divided into several groups:
X-radiation—detection by illuminating the cast by an X-ray equipment. It is universal though costly to operate and service.
Mechanical—by means of penetrating the passages by a needle tool or other mechanical object. Short passages or entryways of the passages close to the openings can be inspected that way. It is manual work intensive, subjective, error prone.
Optical—by means of light emission and measurement of light reflection of the blocked passages. The method uses light reflection of a metal alloy, the product is made of. The principle is in more details described below, where it is directly compared to the proposed method of inspection that is subject-matter of the invention.
Flowtest—measurement of air flow through the passages in particular of the coolant passages. It is a global method, where all passages are measured simultaneously. It is incapable of reliable detection as the air can easily find “detour” routes next to blocked passages (via longer routes of other passages) and that is not disclosed by measurement and the sought after defect is not reliably detected.

A method of and device for optical inspection of blockage of passages, in particular of cylinder head under patent U.S. Pat. No. 7,602,486 B2 is the most similar solution to the proposed method of passage inspection in particular of a cast cylinder head. The described method and device operate on the principle of optical fibres, which serve to emit light into passages. At the same time they serve to receive reflected light and to its conversion to the measuring sensor. After the described method if there is a blockage in the passage caused by an alloy, the cast is made of, the light reflects back to the original fibre optic probe. The said light is analysed and by its quantity the presence and extent of blockage is determined.

The method may have several disadvantages when comparing to the proposed inspection method. They comprise in particular:
A problem of detecting presence of dark clumps of sand of the original passage casting mould as insufficient amount of light, unlike from the blockages caused by the metal alloy itself, is reflected.
A problem of defect measuring and detecting deeper in the passages, in particular of the coolant passages, as in multiple reflection of light through a complex shape of the passages, the reflected light caused by the blockage is undistinguishable from natural reflection caused by a rough surface of passages.

Passages of the product, which can be e.g. the coolant passages of cylinder heads of an engine, passages can contain various obstructions that hinder the required flow of a coolant through the said passages and may result in damage of the engine in a course of the operation. The damages include, among others, in particular:
Complete sealing of the passage by the alloy, in particular as a result of sand mould breaking before or during the casting process.
Partial leakage into the passage by the alloy, in particular as a result of a rupture or breaking of the sand mould before or during the casting process.
A sand mould residuum remains in the passage and partially or complete blocks it.
Sand baked on a passage wall partially or completely blocks the passage.
Extrinsic object in the passage, which partially or completely blocks it.

In case of the said defect the flow of the coolant is reduced. Such a condition needs to be identified during the production process and a sufficient quality of the product before their consequent use for the intended purpose shall be provided.

### SUMMARY OF THE INVENTION

Solution of the present invention is based on measurements of light passing through passages, in particular of the coolant passages. The principle is based on the use of measuring probes having measuring elements of emitting elements and receiving elements. A cast is inspected so that the specifically positioned emitting and receiving elements are moved toward and/or inserted into the designated place of the product. Consequently, each emitting element subsequently lights up separately or in selected groups that do not affect each other and a response in respective receiving elements is measured. For those receiving elements where there is an expected passage of light, i.e. they have sufficiently direct route for any measurable amount of light passing from the emitting element to the receiving element, the measured signal is sufficiently amplified and analysed if the coming light has sufficient intensity. If the measured value differs from the expected one, an extent of the defect is analysed.

Summary of the invention is in particular:
Measurement of the power of light in successive lighting of one emitting element or a selected group of emitting elements and measurement of a response on receiving elements and evaluation of signals.
Each type of casting has a specific shape of the measured passages, and thus has a specifically designed one or more sets of the measuring probes having specific positions of emitting and receiving elements on them. Each assembly all at once moves toward or inserts into the cast to perform the measuring. Separate assemblies move toward or insert consecutively and in sequence.
The assemblies are designed so that all parts of product passages, such as the coolant passages of the cylinder head, necessary to be inspected on the cast are covered by means of openness measuring of passages corresponding to the routes between all specified pairs of the emitting element-receiving element.
Thanks to the successive measuring by one emitting element or in groups that do not affect each other, one probe can have both emitting and receiving elements, if necessary and if shape and structure of the probe make it possible. Emitting and receiving elements in one probe never form a pair that would measure the reflection of light from a blockage in the passage.
Use of wavelength in the visible spectrum range and/or in the infrared range from 400 nm to 1500 nm (a difference compared with an ultrasound test, where waves spread by other means with different attenuation on the routes, which we do not want to monitor in the respective measuring).
Thanks to use of transmission of light of the determined wavelength the routes, which the light passes through and which are measured and analysed are quite accurately under control. That is a major advantage to the FlowTest, where the routes of the passing air are not under control.
Use of signal amplification by an amplifier having selective amplification of 70 to 100 dB is appropriate, to amplify the signal to measurable level while surrounding interference, in particular of surrounding light interference as well as power supply or surrounding electromagnetic interference, are eliminated.

The above cited disadvantages of known methods of product passage openness inspection, in particular of the coolant passages of the cylinder head, are largely eliminated by this invention. Its subject-matter is that the product, which passages are to be checked, is brought to the measuring position, at least one measuring probe containing at minimum one emitting element and at minimum one receiving element is moved toward or inserted into the openings of the product passages or an assembly of measuring probes consisting of at minimum one measuring probe containing at minimum one emitting element and at minimum one measuring probe containing at minimum one receiving element is moved toward or inserted into the opening of the product passages, following the part of the assembly consisting of at minimum one measuring probe containing at minimum one emitting element emitting in range of visible spectrum and/or infrared spectrum in the region of wavelength of 400 nm to 1500 nm is turned on and on the measuring probe, containing the receiving element that forms a pair with the turned-on emitting element a response is measured—a signal, size of which depends on amount of passed light, signal level is analysed and compared with an expected value. The procedure is then repeated with other sets of emitting and receiving elements on an identically arranged assembly of measuring probes or alternatively arranged assembly of measuring probes moved torward or inserted into another passage opening(s) of the product, until a required amount of measuring enabling to analyse openness of requisite amount of passages in the whole inspected product is achieved. Individual assemblies of measuring probes are designed so that the routes between all designed pairs of emitting element-receiving element cover sufficient amount of passages, or all passages, for evaluation of the analysed product.

According to one embodiment one measuring probe containing an emitting element forms a pair with at minimum one measuring probe containing at minimum one receiving element.

According to a preferred embodiment, the measured response—a signal on the receiving element is amplified by a signal amplifier. The amplifier having selective amplification of 70 to 100 dB can be used as a suitable amplifier.

According to another preferred embodiment, after the product is positioned into a measuring position it is advisable to check a position and shape of the passage openings in order to prevent damage of measuring probes.

Another subject-matter of the invention is a device for analysing openness of passages of a product, in particular of the coolant passages of cylinder heads, the device containing at minimum one set of measuring probes consisting of at minimum one measuring probe comprising at minimum one emitting element for emitting in range of visible spectrum and/or infrared spectrum in the region of wavelength of 400 to 1500 nm and at minimum one measuring probe containing at minimum one receiving element for reception of a signal from the emitting element, the said assembly of the measuring probes is connected to a measuring probe control unit, which is connected to a measuring and communication unit, which is connected to a control unit—a computer, which a visual display unit is possibly connected to.

A system consists of a control computer, measuring cards arranged in the measuring and communication unit, the amplifier having selective amplification of at minimum 70 to 100 dB and measuring probes. The probes are connected to the amplifier and the amplifier output is connected to the measuring card.

According to a preferred embodiment one measuring probe may contain one or more emitting elements and/or one or more receiving elements.

The measuring probe control unit comprises a signal generator for emitting elements and may include an amplifier of signals from receiving elements.

According to a preferred embodiment the measuring and communication unit comprises measuring cards connected to the signal generator for emitting elements, to the control unit—the computer and may be connected to the amplifier of signals from receiving elements.

The measuring probe consists of a probe body, which contains a main shaft and an arm, the arm contains an outer part, which may be terminated by a head for insertion into the passage opening. The head may contain one or more receiving elements and/or one or more emitting elements or a combination thereof.

It is preferred if the arm is attached to the body of the probe by a joint, allowing a swing motion of the arm and the head may also be attached to the outside part of the arm by another joint.

According to the preferred embodiment the measuring probes may be sliding and/or swinging positioned in the probe holder, which is sliding positioned on sliding mechanisms, wherein the probe holder may be removably arranged to be changed for another probe holder, which has another assembly of measuring probes designed to inspect another type of passages or another type of the product.

According to another preferred embodiment, the holder may be arranged in two or more assemblies of measuring probes for continuous inspection of various types of products having distinct setting and shape of the passage openings and of the passages themselves in the product.

### BRIEF DESCRIPTION OF DRAWINGS

FIG. 1 of the attached drawings illustrates a schematic layout of the passage openness inspection device.

FIG. 2 shows throughput of light between emitting and receiving element through a good passage.

FIG. 3 shows passing of light between emitting element and receiving element through a blocked passage.

FIG. 4 depicts an example of passage openings of the coolant passages of the cast of the three-cylinder engine.

FIG. 5 shows a scheme of a device for moving of probes torward or insertion of probes into a cast.

FIG. 6 illustrates an exemplary shape of the measuring probes having emitting and receiving elements inserted in a tested product.

FIG. 7 shows an example of a shape of a suspension-spring angular probe in an ejected position.

FIG. 8 depicts an example of a shape of a suspension-spring angular probe in the inserted position.

FIG. 9 illustrates an example of a shape of an angular probe with a side swing and

FIG. 10 shows a flow chart of a method of the cast passage inspection.

### EXEMPLARY EMBODIMENTS

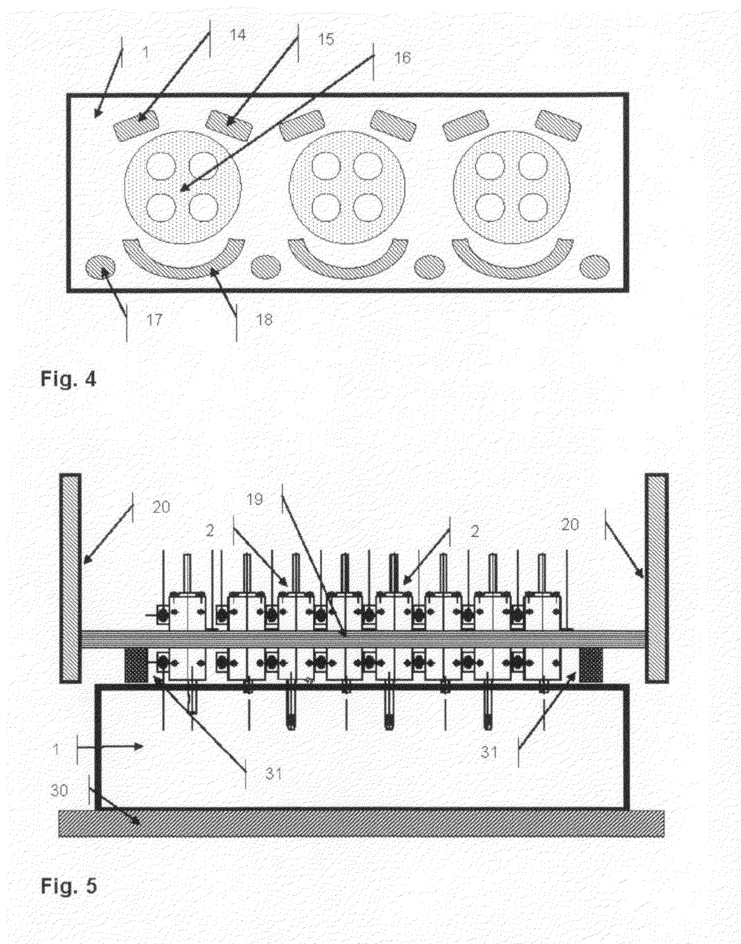

FIG. 4 shows a possible shape of a product, be it a combustion side of the cylinder head, on which there are distinctive openings 14, 15, 17, 18 of coolant passages and openings 16 of the combustion chamber of the cylinder. Layout of openings 14, 15, 17, 18 of the passages differs for different types of products 1 and in general they may appear on any side of the product 1. Between each openings 14, 15, 17, 18 of coolant passages there are differently shaped passages, which are variably connected, divided and furcated.

The proposed method of the passage openness inspection uses measuring probes 2, which are moving toward or inserting into openings 14, 15, 17, 18 of the passages. Measuring probes 2 are designed specifically for each type of the product. A number and position of the probes 2 is given by an amount of passage openings and the shapes of the passages between the openings. Emitting or receiving elements may be present on the probes. Light-emitting diodes may be used as emitting elements and photo diodes may be used as receiving elements. The method for inspection uses passage of light emitted by the emitting element through the passages to the receiving element. Each pair of the emitting and receiving elements of the measuring probe assembly represents a single potential measured passage. Not all combinations of pairs of emitting and receiving elements have to be used for measuring and analyzing; only those that enable all required parts of the passages of product 1 to be covered by checking.

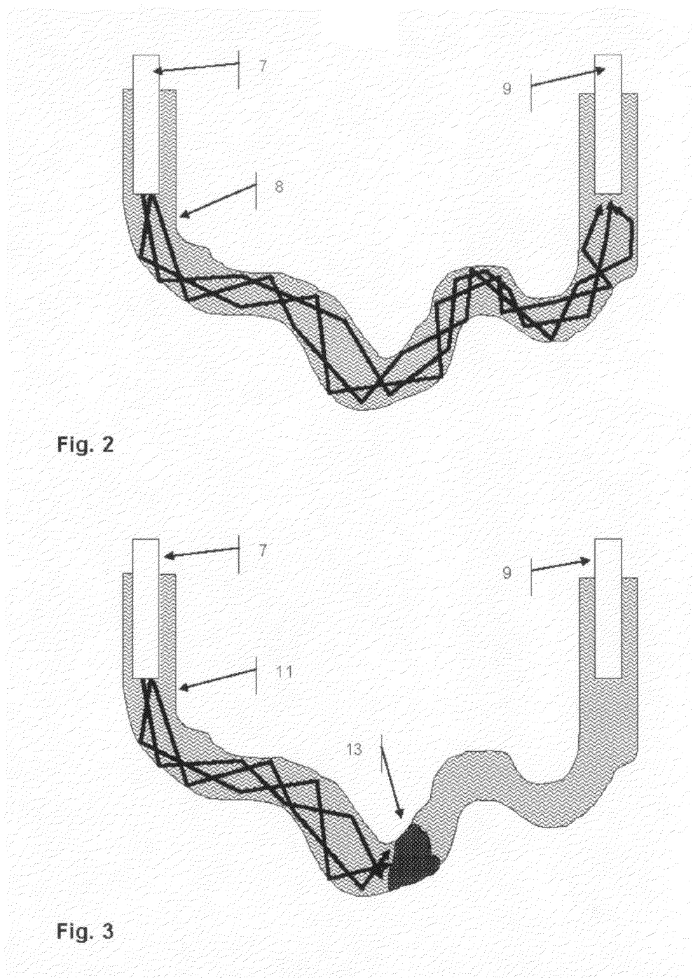

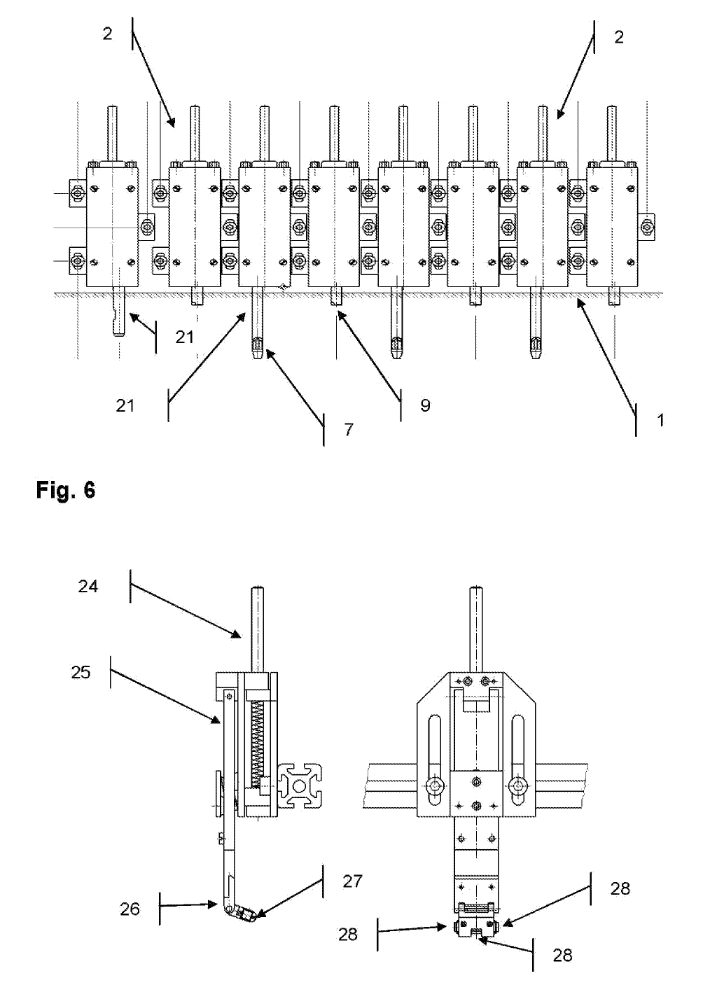

In order to achieve a desired level of inspection, it is in general possible to use one type of cast and several assemblies of measuring probes. Each assembly consists of specifically positioned probes having emitting and receiving elements. All measuring probes 2 of one assembly simultaneously move toward or insert into product 1, in order to perform measuring within the given assembly of probes (FIG. 5 and FIG. 6). Respective assemblies of measuring probes 2 move toward and withdraw in sequence—successively. After performing measurements by all measuring probes 2 in all assemblies the desired quality of the passages of product 1, assigned to the said product 1 is evaluated. As depicted on FIG. 2, light passes via passage 8 from measuring probe 2 having emitting element 7 to measuring probe 2 having receiving element 9. As there is no blockage in the passage, certain amount of light reaches the receiving element 9 thanks to reflection from passage walls. FIG. 3 illustrates a situation, where in passage 11 there is obstruction 13, which hinders passing of light through passage 11 from emitting element 7 to receiving element 9. Contrary to situation depicted on FIG. 2 a smaller amount of incoming light shall be measured on the receiving element 9. The difference from the expected value of the incoming light can be evaluated and an existence and/or extent of a blockage or other damage of passage 11 can be determined.

In order to accurately locate the position of a defect and to not mutually affect the measurements of passages 8, 11, successive measuring of the passages is used by the proposed measuring method. In general, this means that at a certain moment only one emitting element 7 shines, or several emitting elements 7 within one assembly of measuring probes 2 shine, whose emitted light does not mutually affect on any receiving element 9, which is evaluated at the particular measuring. At a certain moment of measuring a measurable amount of light from only one emitting element 7 may come to one receiving element 9. The proposed openness inspection method works according to a procedure depicted on FIG. 10. Thanks to the successive light of the emitting elements 7 and the measurement of the amount of passed light on the respective receiving elements 9 the proposed method is able to more precisely locate a position of the passage damage and to more precisely determine a possible extent of the damage of passages 8, 11.

Measuring probes 2 are constructed so as to allow optimal and repeated positioning of the emitting elements 7 and receiving elements 9 in passage openings so that the measured values of openness are stable and repeatable in multiple measuring. A part of the assembly of measuring probes 2, which are inserted in product openings 1 can be seen on FIG. 6. Outer parts 21 of the probes, which can have various shapes depending on the shape of openings 14, 15, 17, 18 of the passages and on the shape of the passages 8, 11 themselves, are inserted into the openings. Emitting elements 7 and receiving elements 9 can be variably placed on the measuring probes 2.

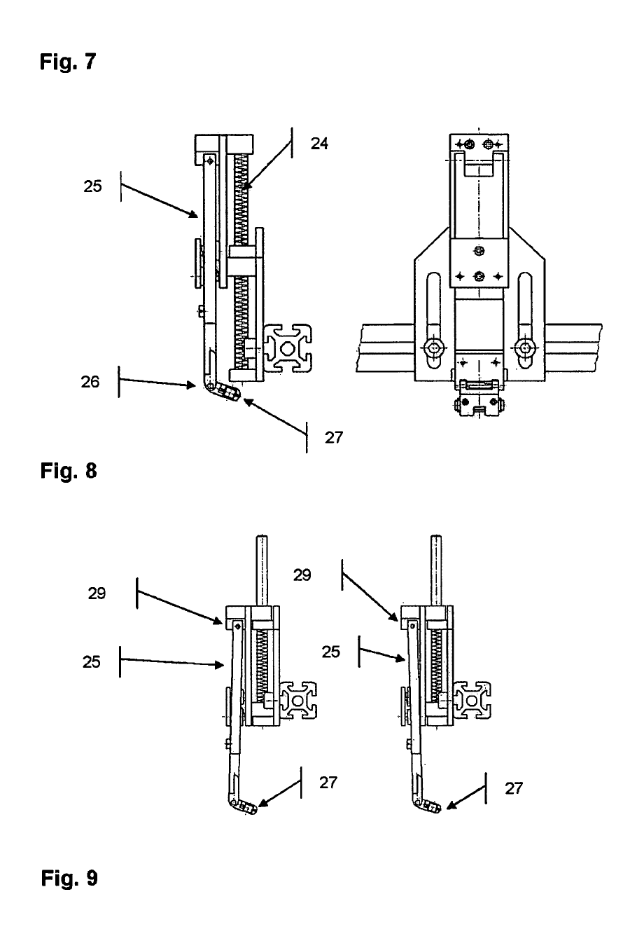

The proposed measuring probes 2 which are inserted into passage openings 14, 15, 17 and 18 can be constructed so as to include suspension/spring mechanism, which enables shifting of outer part 21 of measuring probe 2 aside from the product 1 in case it is not possible to insert it properly into the respective opening of passage 8, 11. FIG. 7 illustrates measuring probe 2, which contains a primary shifting axis 24, which the whole probe can shift along. At the same time on the measuring probe 2 there is an arm 25 of the outer part of the measuring probe 2, which can shift by means of the respective mechanism. The depicted measuring probe 2 also contains swing joint 26 on arm 25 of outer part 21 of measuring probe 2, enabling probe 2 to achieve optimal position of head 27 of outer part of the probe with the respective assembly of measuring elements 28, i.e. emitting elements 7 or receiving elements 9, inside the openings of passage 8, 11, which it is inserted into. FIG. 8 illustrates identical probe, which arm 25 of outer part of the probe is on primary axis 24 shifted aside so that neither outer part 21 of the probe nor its head 27 are inserted into the opening of the product passage 1.

FIG. 7 also depicts that several measuring elements 28 either emitting elements 7 or receiving elements 9, according to the specific needs of the inspection of the given product type can be placed on head 27 of outer part 21 of the probe.

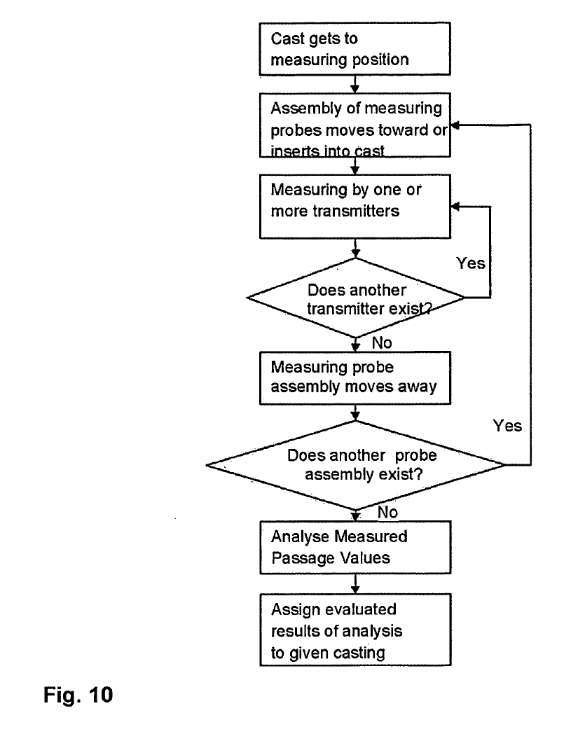

The design of measuring probes 2 must also be resistant to a minor deflection in position, shape and dimensions of passage openings. FIG. 9 depicts an example of a possible mechanism of tilting arm 25 of outer probe 2. The arm can turn in joint 25 so that head 27 of the outer part of the probe at the end of arm 25 can adjust to a layout and shape of opening of passage 8, 11 on product 1. FIG. 9 shows possible end tilting positions of arm 25 in joint 29. A specific method of construction of each probe 2 is based on relevant requirements for position of emitting elements 7 and receiving elements 9 and layout and shape of passage openings 14, 15, 17 and 18 and the shape of passages 8, 11 themselves, in which emitting elements 7 and receiving elements 9 are to be inserted or moved toward.

FIG. 5 shows possible solutions of an equipment for moving of probes 2 toward or insertion of measuring probes 2 into inspected product 1. The device consists of probe holder 19, on which measuring probes 2 are placed. Probe holder 19 moves up and down the relevant shifting mechanisms 20. Precise positioning of probe holder 19 against product 1 is achieved by using precise fixture 30, on which product 1 is placed in a specific and repeatable position. Precision of shifting and insertion depth of probes 2 on holder 19 may be either solved by a mechanical backstop element 31 of the probe holder against product 1, against precise fixture 30, or by use of a precise controlled positioning probe holder 19 on shifting mechanisms 20.

In general it is possible that the measuring probes 2 will insert and move toward the product by different manners and from different sides as passage openings 14, 15, 17 and 18 to be inspected can be located on different sides of the products. It is also possible that some probes 2 will move toward openings 14, 15, 17 and 18 or insert into openings 14, 15, 17 and 18 by means of various swinging and sliding mechanisms.

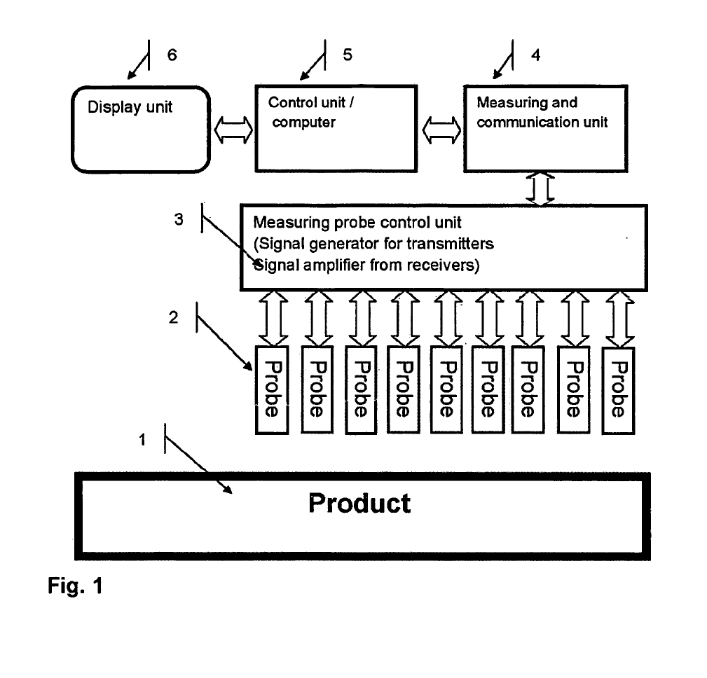

The whole equipment for inspection of passage openness 8, 11 of product 1, in particular of the coolant passages of the cylinder heads (FIG. 1) consists of measuring probes 2, which are connected to a measuring probe control unit 3. The measuring probe control unit 3 provides for generation of signals for emitting elements 7, as well as for receiving and amplifying of the signals from receiving elements 9. Amplified signals are measured by means of measuring and communication unit 4. Control unit 5 or a computer to provide further processing and analysis of the measured signals may also be a part of the device. Display unit 6—a display serving to visualise a progress and outcome of the measurement as well as to adjust a method and inspection parameters may also be a part of the equipment.

Equipment for inspection of passage openness, in particular of the coolant passages of the cylinder heads as depicted on FIG. 5 can also be constructed so that probe holder 19 can be easily disconnected from the device and replaced by another probe holder 19 having another assembly of measuring probes 2, which may serve for another type of inspection of passages 8, 11, or for inspection of passages of another type of product 1. The same applies for the possibility of replacing precise fixture 30 for placing and positioning of the product during inspection.

Equipment for inspection of passage openness of product 1, in particular of the coolant passages of the cylinder heads can also be constructed so that several assemblies of measuring probes 2 placed on holders 19 of the probes, which serve for continuous measuring of various types of products 1 having distinctive layout and shapes of passage openings 14, 15, 17 and 18 and of passages 8, 11 themselves on product 1 are placed on it. On the said equipment it is possible to inspect various products without necessity of rebuilding the device.

Equipment for inspection of passage openness of product 1, in particular of the coolant passages of the cylinder heads can have shifting of the products to be inspected designed in several ways. The device can be for example separate having manual manipulation of the products into the measuring position by an operator of the device. The equipment can also have a built-in shifting or other manipulating mechanism, which moves the measured product into various measuring positions (for example for measuring with various assemblies of the measuring probes) within the equipment. The equipment can also be built in an automated production line, where the products get into the measuring position on a conveyor. The equipment can also be constructed so that the products are inspected on the conveyor on different places by different assemblies of the measuring probes.

Equipment for inspecting the openness of passages, in particular the coolant passages of the cylinder heads can be also constructed so that it includes a camera system serving to inspect presence, shape and layout of openings of the passages prior to the start of the passage openness inspection itself after the described method, which is subject-matter of the invention. On the basis of the outcome of the evaluation from the camera system the equipment can decide whether to run the subsequent inspection or not. If the camera system identifies that some opening of the passage does not meet the required parameters, that product can be marked as defective. For example if some passage is completely absent, measuring probes 2 can be protected from possible damage during moving toward or inserting into the missing or damaged opening of passages 8, 11 by leaving out the subsequent inspection.

1. A method of openness inspection of passages of a product, in particular of a coolant passages of a cylinder head characterized in that a product, passages of which are to be checked, is brought into a measuring position, a minimum of one measuring probe comprising at minimum one emitting element and at minimum one receiving element is moved toward and inserted into openings of the product passages, or an assembly of measuring probes consisting of at minimum one measuring probe containing at minimum one emitting element and at minimum one measuring probe containing at minimum one receiving element is moved toward and inserted in the openings of the product passages, consequently a part of the assembly formed by at minimum one measuring probe containing at minimum one emitting element with emission in a range of visible spectrum and/or infrared spectrum in the region of the wavelength of 400 nm to 1500 nm is turned on and a response—a signal, which quantity depends on an amount of passed light is measured on the measuring probe containing a receiving element that forms a pair with the just working emitting element and the signal quantity is analysed and compared with an expected value; wherein the procedure is repeated with another assembly of emitting and receiving elements on an identically arranged assembly of measuring probes or a differently organised assembly of the measuring probes moved toward or inserted into another opening(s) of the product passages until a required amount of measurements is achieved in order to be able to analyse openness of the requisite amount of passages in the whole inspected product while the particular assemblies of the measuring probes are designed so that the routes between all designed pairs of emitting element-receiving element cover sufficient amount of passages for evaluation of the analysed product.

2. The method of openness inspection of the product passages according to claim 1 characterized in that one measuring probe comprising an emitting element forms a pair with at minimum one measuring probe containing at minimum one receiving element.

3. The method of openness inspection of the product passages according to claim 1 characterized in that a measured response—a signal on the receiving element, is amplified by a signal amplifier.

4. The method of openness inspection of the product passages according to claim 1 characterized in that a position and shape of the passage openings are checked after positioning the product into a measuring position.

5. A device for analysing passage openness of a product, in particular of coolant passages of a cylinder head according to claim 1 characterized in that it contains at minimum one assembly of measuring probes (2) formed by at minimum one measuring probe comprising at minimum one emitting element (7) for emitting in a range of the visible spectrum and/or infrared spectrum in the region of wavelength of 400 nm to 1500 nm and at minimum one measuring probe containing at minimum one receiving element (9) for receiving a signal from the emitting element (7), the said assembly of the measuring probes (2) is connected to a control unit (3) of measuring probes (2), said unit is connected to a measuring and communication unit (4), which is connected to a control unit (5)—a computer, which a visual display unit (6) is possibly connected to.

6. The device for analysing passage openness of the product according to claim 5 characterized in that one measuring probe (2) comprises at minimum one emitting element (7) and at minimum one receiving element (9).

7. The device for analysing passage openness of the product according to claim 5 characterized in that a measuring probe control unit (3) comprises a signal generator for emitting elements (7) and an amplifier for signals from receiving elements (9).

8. The device for analysing passage openness of the product according to claim 5 characterized in that a measuring and communication unit (4) contains measuring cards, which are connected to the amplifier of signals from receiving elements (9), to the generator of signals for emitting elements and to the control unit (5)—the computer.

9. The device for analysing passage openness of the product according to claim 5 characterized in that t the measuring probe (2) consists of a probe body, which comprises a main axis (24) and an arm (25), the arm contains an outer part (21) ended by a head (27) to be inserted to the passage opening, the head (27) comprises at minimum one receiving element (9) and/or at minimum one emitting element (7) or a combination thereof.

10. The device for analysing passage openness of the product according to claim 9 characterized in that the arm (25) is attached to the body of the probe (2), by a joint (29) and the head (27) is attached to the outer part (21) of the arm (25) by a joint (26).

11. The device for analysing passage openness of the product according to claim 5 characterized in that the measuring probes (2) are sliding and/or swinging positioned in the probe holder (19), which is sliding positioned on sliding mechanisms (20), wherein the probe holder (19) is replaceable for another probe holder (19) having a different assembly of measuring probes (2) designated for inspection of a different type of passages (8, 11) or of a different type of the product (1).

12. The device for analysing passage openness of the product according to claim 5 characterized in that at minimum two assemblies of measuring probes (2) are arranged on the holder (19) for continuous analysing of various types of products (1) with distinctive layout and shape of passage openings (14, 15, 17 and 18) and of passages (8, 11) themselves on the product (1).
